(19) United States
(12) Patent Application Publication
(10) Pub. No.: US 2011/0150195 A1
(43) Pub. Date: Jun. 23, 2011

(54) INTERACTIVE INTERCOM SYSTEM FOR BUILDING ENTRY CONTROL

(76) Inventor: David L. Oblad, San Bernardino, CA (US)

(21) Appl. No.: 12/916,387

(22) Filed: Oct. 29, 2010

Related U.S. Application Data
(60) Provisional application No. 61/256,245, filed on Oct. 29, 2009.

(51) Int. Cl. H04M 11/00

(52) U.S. Cl. 379/102.06

(57) ABSTRACT

An interactive building entry control system serves as an “electronic doorman.” The system includes an interactive intercom system that acts as an intermediary between visitors to a building and residents of the building. The system allows a resident to identify a visitor without directly talking to the visitor. The system records a message from the visitor and relays the message to a communication device of the selected resident of the building. The resident can then make a decision to grant or deny entry without talking directly to the visitor. When the resident grants entry, the system signals an entry door to the building to unlock. When the resident denies entry, the entry door remains locked, and the system informs the visitor that entry has been denied, without informing the visitor of the cause of the denial.

### CROSS-REFERENCE TO RELATED APPLICATION

This application claims priority, under 35 U.S.C. §119(e), from U.S. Provisional Application No. 61/256,245, filed Oct. 29, 2009, the disclosure of which is incorporated herein by reference in its entirety.

### FEDERALLY-SPONSORED RESEARCH OR DEVELOPMENT

Not Applicable.

### BACKGROUND

This disclosure relates to building entry control systems. In particular, it relates to building entry control systems that include an intercom system between a main entryway and each of a plurality of apartments, offices, etc.

Access to a multi-resident building, such as an apartment or office complex, is commonly controlled via a telephone-type entry device. A visitor selects a resident (or occupant) from a directory in the entry device and communicates with the selected resident to request entry into the building. The entry unit may place a local telephone call to the resident through the telephone company or through an intercom system local to the building. The resident talks to the visitor directly in order to decide whether to grant or deny entry. Granting or denying entry is commonly done by the resident selecting a key on the resident's telephone keypad. When entry is granted, the entry device engages a relay that controls a door lock on the visitor entry.

A visitor who is denied entry to the building may become troublesome and create problems for the resident who chooses to deny access, and for other others in the building. A building doorman can reduce or prevent such problems by serving as an intermediary between the visitor and the residents. Providing a doorman, however, can be expensive, particularly for a building with a small number of residents to share the expense of the salaries and benefits required to hire doormen for around-the-clock duty.

### SUMMARY

Accordingly, there is a need for an automated system (an “electronic doorman”) to perform the “gatekeeper” function typically provided by a live doorman. Specifically, the electronic doorman provides an interactive intercom system to serve as an intermediary between visitors to a building and residents of the building. The electronic doorman allows a resident to identify a visitor without directly talking to the visitor. The resident can then make a decision to grant or deny entry without ever talking directly to the visitor.

In one aspect, a device or system for controlling access or entry to a building in accordance with an exemplary embodiment of this disclosure may be broadly characterized by a network interface coupling a speakerphone at the building entry with a resident communication device (either an intercom or a telephone with an intercom function) in each of a plurality of apartments or offices; a voice recorder and player coupled to the speakerphone and the network interface; an output line for transmitting a signal from each resident communication device to unlock an entry door of the building; and a microcomputer coupled to the network interface, the speakerphone, the voice recorder and player, and the output line, wherein the microcomputer is configured to (a) receive a selection signal indicating a resident of the building selected by a visitor to the building, (b) operate the voice recorder and player and the speakerphone to record an identification message from the visitor in response to the selection signal, (c) signal the resident communication device (“RCD”) of the selected resident; (d) operate the voice recorder and player to play the recorded message for the selected resident, and (e) unlock the entry door only when an entry signal is received from the selected resident on the output line.

In another aspect, a method for controlling access or entry to a building by a visitor in accordance with an exemplary embodiment of this disclosure may be broadly characterized by (a) receiving a selection signal indicating a selected building resident from the visitor; (b) recording an identification message from the visitor in response to the selection signal; (c) sending the identification message to a resident communication device (“RCD”) of the selected resident; and (d) denying the visitor access to the building unless an entry signal is received from the RCD of the selected resident.

### BRIEF DESCRIPTION OF THE DRAWINGS

FIG. 1 is a block diagram of an exemplary embodiment of a building entry control system in accordance with aspects of the disclosure; and

FIGS. 2A and 2B comprise a flowchart of an exemplary embodiment of a process for controlling entry to a building in accordance with aspects of the disclosure.

### DETAILED DESCRIPTION OF THE DISCLOSURE

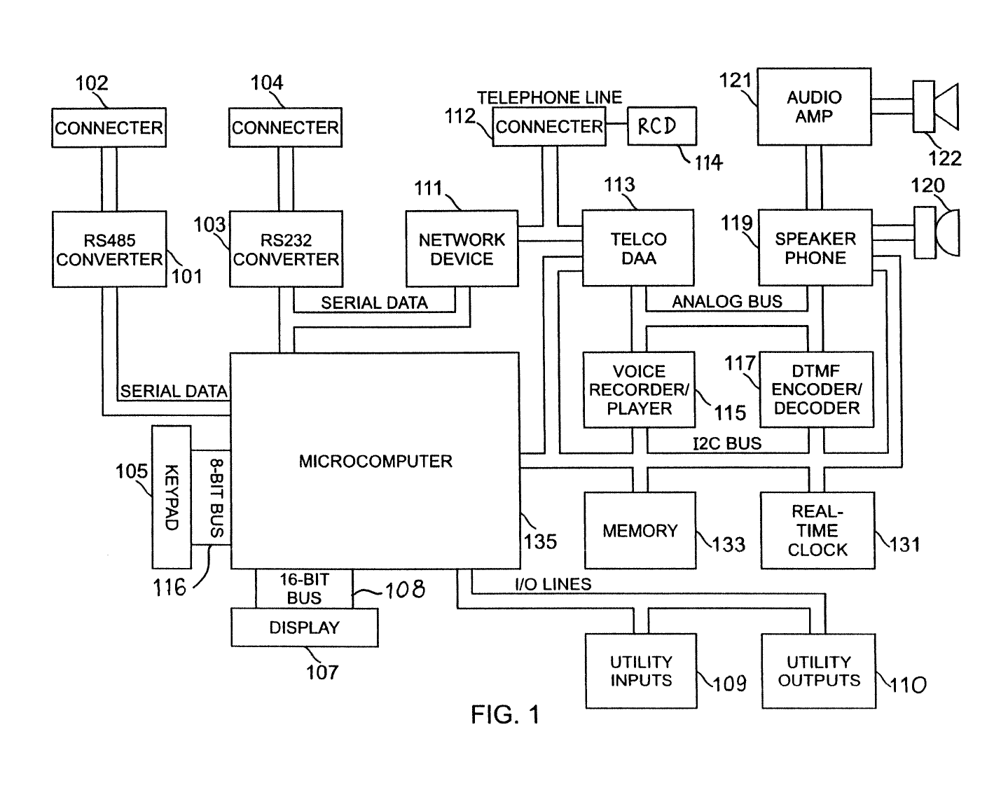

FIG. 1 is a block diagram of portions of an exemplary embodiment of an interactive building entry control system in accordance with aspects of the disclosure. The system in accordance with this embodiment includes a microcomputer 135 that executes program steps to control the functions of the system. The program steps may be stored in memory of the microcomputer 135 or in other memory of the entry control system, or it may be loaded from a program store external to the entry control system, or otherwise provided. The entry control system includes a memory 133 coupled to the microcomputer 135 via an inter-integrated circuit (I2C) bus. The memory 133 may be used to store instructions and data used by the microcomputer 135. The entry control system also includes a real-time clock 131 to provide time-of-day information to the microcomputer 135.

The entry control system includes a data input device such as a keypad 105 advantageously coupled to the microcomputer 135 via conventional means such as an 8-bit bus 106. The keypad 105 may, for example, be a twelve-key telephone-type keypad. The entry control system also includes a display 107 coupled to the microcomputer 135 by conventional means, such as a 16-bit bus 108. The display 107 may, for example, be a dot matrix display (e.g., LED or LCD). Visitors to a building using the entry control system generally enter selections via the keypad 105 and receive instructions via the display 107.

The entry control system includes a network device 111 for communication with output devices, for example, a management system (not shown), to provide service and maintenance. The network device 111 may be, for example, a dial-up modem or a local area network adapter. The entry control system also includes a data access arrangement (DAA) 113 for connection to a telephone line via a telephone line connector 112. The telephone line provides a connection to a resident communication device (RCD) 114 of each of the residents of the building. The RCDs 114 (only one of which is shown for clarity) may be telephones with an integrated intercom function, or stand-alone intercom units. The operation and status of the DAA 113 are controlled by and signaled to the microcomputer 135. For example, the DAA 133 may be commanded to go off-hook.

The entry control system includes a speakerphone 119 to allow a visitor to communicate with residents. The speakerphone 119 may also be used for recording messages from the visitor and playing audio messages to the visitor. The speakerphone 119 is advantageously coupled to the DAA 113 via an analog bus. Control of the speakerphone 119 is provided by the microcomputer 135 via the I2C bus. Audio signals from the visitor are provided to the speakerphone 119 via a microphone 120. Audio signals are provided to the visitor by a speaker 122 that is coupled to the speakerphone 119 via an audio amplifier 121.

The entry control system includes a dual-tone multi-frequency (DTMF) encoder/decoder 117. The encoder aspect may be used, for example, to dial the RCD to call a resident of the building. The decoder aspect may be used, for example, to receive signals from the resident signaling whether a visitor should be granted or denied entry to the building. The DTMF encoder/decoder 117 is coupled to the DAA 113 and the speakerphone 119 via the analog bus. Control and status signals are coupled between the DTMF encoder/decoder 117 and the microcomputer 135 via the I2C bus.

The entry control system includes a voice recorder/player 115. The recorder aspect may be used, for example, to record a message from a visitor to the building. The player aspect may be used, for example, to play the recorded message from the visitor to a resident of the building. The voice recorder/player 115 is coupled to the DAA 113 and the speakerphone 119 via the analog bus. Control and status signals are coupled between the voice recorder/player 115 and the microcomputer 135 via the I2C bus. The voice recorder/player 115 may additionally be used to provide voice commands to a visitor and receive responses from the visitor.

The entry control system also includes an RS-485 converter 101 that is serially coupled to the microcomputer 135. The RS-485 converter 101 may be used to couple, via a first converter connector 102, multiple entry control systems together, for example, in a multi-entry building. The entry control system further includes an RS-232 converter 103 that is serially coupled to the microcomputer 135. The 232 converter 103 may be used to couple, via a second converter connector 104, the entry control system to an external computer (not shown), for example, to program resident information.

The entry control system includes a set of utility inputs 109 and utility outputs 110. The utility inputs 109 are used to couple the microcomputer 135 to status signals, for example, a signal indicating that an entry door to the building is ajar. The utility outputs 110 are used to couple the microcomputer 135 to control signals, for example, a signal to enable unlocking the building entry door.

The block diagram of FIG. 1 is exemplary only, and any particular embodiment may omit some components and may include other components. For example, an embodiment may include a battery backup power supply. Additionally, the interconnections of the components may be differently provided. For example, different types of buses may be used or components may be connected to different ones of the buses.

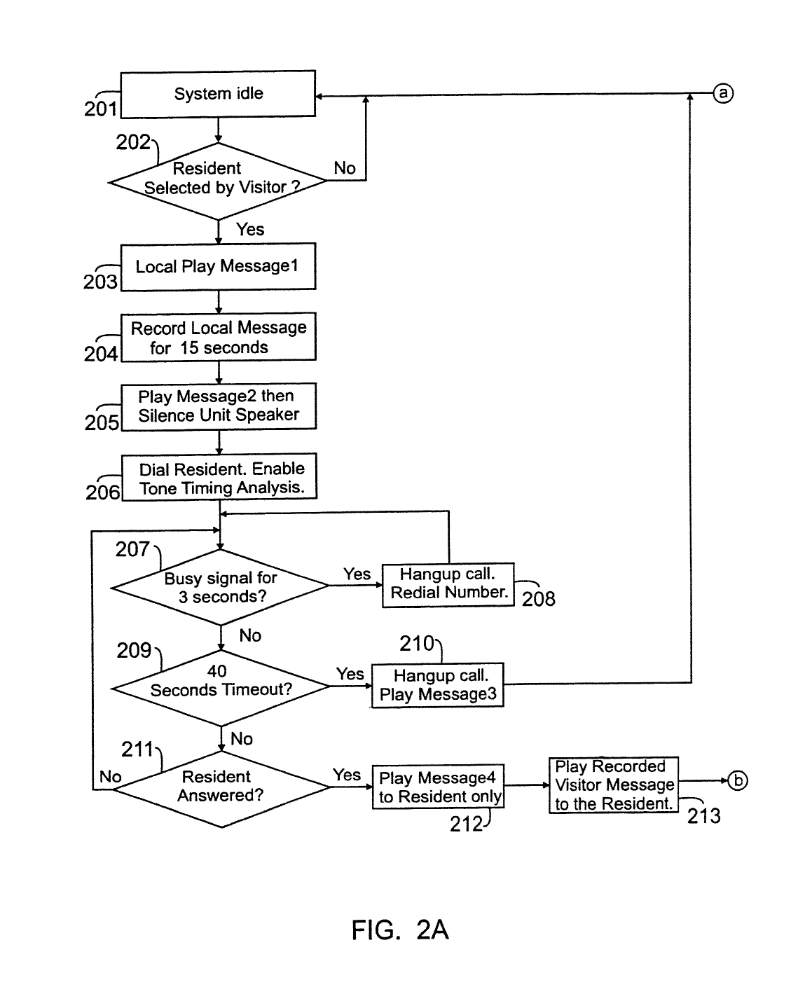

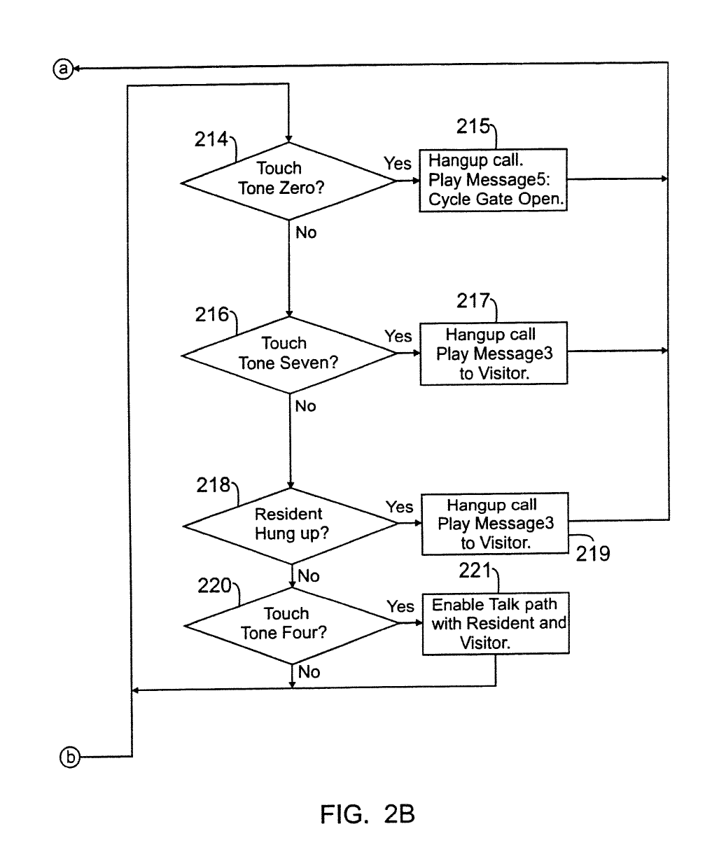

FIGS. 2A and 2B comprise a flowchart of an exemplary embodiment of a process for an entry control system in accordance with aspects of the disclosure. The process may be performed by hardware, software, or a combination thereof. The process may be performed by the exemplary entry control system described above and shown schematically in FIG. 1, or any equivalent thereto. Additionally, instructions for performing the process may be stored on a computer-readable medium such as a compact disc (CD), digital versatile disk (DVD), read-only memory (ROM), floppy disk, hard disk, or flash drive. The process acts as an intermediary between residents of a building and visitors to the building and provides an electronic “doorman” to grant or deny visitors access to the building.

The process begins in an idle state 201. Aspects of the system may be initialized or set to default values in the idle state. The process continues to step 202.

In step 202, the process checks for selections of a resident by a visitor. Generally, the visitor is presented with a directory of residents, for example, by means of the display 107 of the entry control system of FIG. 1. The visitor may select a resident using the keypad 105 of the entry control system of FIG. 1. If a resident is selected by a visitor, the process continues to step 203; otherwise, the process returns to step 201.

In step 203, the process plays a first recorded message to the visitor with introductory instructions on the use of the entry control system. The first recorded message may state, for example, “Hello. I am an Electronic Doorman. Please state your name and the reason for your visit, and I will contact your party.” The process may use the voice recorder/player 115 of the system of FIG. 1 to play the message, with the sound emanating locally from the speaker 122.

In step 204, the process records a message from the visitor. The process may use the voice recorder/player 115 of the system of FIG. 1 to record the visitor's message with the sound received locally by the microphone 120.

In step 205, the process plays a second recorded message to the visitor with further instructions. The second recorded message may state, for example, “Please wait while I attempt to contact your party. This should only take a moment.” Playing of the second message is the same or similar to playing the first message in step 103. In one embodiment, the process silences the speaker 122 during subsequent steps of attempting to contact the selected resident so that the visitor is unaware of these steps, including whether the selected resident is present. In another embodiment, the process plays recorded background music through the speaker 122 while attempting to contact the selected resident.

In step 206, the process initiates a call by activating (“dialing”) the RCD of the selected resident. Generally, the process dials the number associated with selected resident, for example, using the DAA 113 and DTMF encoder/decoder 117 of the entry control system of FIG. 1. The process also starts a call timer.

In step 207, the process checks for three seconds of busy signal in response to dialing the selected resident. If the busy signal is detected, the process continues to step 208; otherwise the process continues to step 209. In step 208, the process hangs up the busy call and redials the RCD of the selected resident. The process then returns to step 207. In some embodiments, the number of redials is limited, and when the limit is reached, the process may treat the call as unanswered, as in step 210.

In step 209, the process checks whether the call timer started in step 206 has reached a limit, for example, forty seconds. If the call timer has reached the limit, the process continues to step 210; otherwise, the process continues to step 211. In step 210, the process plays a third recorded message to the visitor to indicate that the electronic doorman cannot grant entry. The third or entry denial message may state, for example, “I am sorry but I cannot grant entry at this time. It has been a pleasure to serve you.” The process then returns to the idle state 201.

In step 211, the process checks whether the selected resident has answered the call. If the call is answered, the process continues to step 212; otherwise, the process returns to step 207. In step 212, the process plays a fourth recorded message to greet the resident. The fourth or resident greeting message may state, for example, “This is your Electronic Doorman. You have a visitor who left this identification message.” In step 213, the process plays the message recorded by the visitor in step 204. As an example, a visitor message may have stated, “This is Sally from the Florist. I have a delivery for a Ms. Evans.”

In step 214, the process checks for a touchtone signal indicating that the resident wishes to grant entry to the visitor. For example, the DTMF encoder/decoder 117 of the entry control system of FIG. 1 may signal detection of tones corresponding to a touchtone zero. If the resident wishes to grant entry, the process continues to step 215; otherwise the process continues to step 216. In step 215, the process plays a fifth recorded message to the visitor. The fifth or entry granted message, for example, may state, “You have been granted entry. Thank you.” In step 215, the process also ends the call to the selected resident and unlocks the entry door, for example, using the utility outputs 110 of the entry device of FIG. 1. The process then returns to the idle state 201.

In step 216, the process checks for a touchtone signal indicating that the resident wishes to deny entry to the visitor. For example, the DTMF encoder/decoder 117 of the entry control system of FIG. 1 may signal detection of tones corresponding to a touchtone seven. If the resident wishes to deny entry, the process continues to step 217; otherwise the process continues to step 218. In step 217, the process plays the third recorded message (the “entry denied” message) to the visitor. The process also ends the call with the selected resident. The process then returns to the idle state 201.

In step 218, the process checks whether the resident has hung up the call. If the resident hangs up the call, the process continues to step 219; otherwise the process continues to step 220. In step 219, the process plays the third recorded message (“entry denied”) to the visitor. The process then returns to the idle state 201. Note that in the embodiment of FIGS. 2A and 2B, the same recorded message is played to the visitor whether the resident actively denied access or did not respond to the request for access.

In step 220, the process checks for a touchtone signal indicating that the resident wishes to talk with the visitor. For example, the DTMF encoder/decoder 217 of the entry device of FIG. 1 may signal detection of tones corresponding to a touchtone four. If the resident wishes to talk with the visitor, the process continues to step 221; otherwise the process returns to step 214. In step 221, the process enables an audio path between the resident and the visitor. The process may use the speakerphone 119 of the entry control system of FIG. 1 to enable communication between the resident and the visitor. The process then returns to step 214.

The process accordingly allows visitors to a building to be granted or denied entry to building by a resident of the building with the resident isolated from the visitor throughout the process unless the resident decides to talk directly with the visitor.

The flowchart of FIGS. 2A and 2B is exemplary only, and an embodiment may omit some steps and may include other steps. For example, a particular embodiment may include a step in which the process checks for a touchtone signal indicating that the resident wishes to grant access to a delivery closet to the visitor, and if such a signal is detected, informs the visitor and unlocks the delivery closet. Another embodiment may include a timer that limits the elapsed time in one or more of the steps 214-221. Additionally, in some embodiments, steps of the process may be ordered differently. For example, step 220 may be performed before step 218, and step 216 may be performed before 214.

What is claimed is:

1. A system for controlling entry to a building, comprising:
a network interface coupling a speakerphone near an entry of the building with a resident communication device associated with each of a plurality of residents of the building;
a voice recorder and player coupled to the speakerphone and the network interface;
an output line for transmitting a signal to unlock an entry door of the building; and
a microcomputer coupled to the network interface, the speakerphone, the voice recorder and player, and the output line;
wherein the microcomputer is configured to:
(a) receive a selection signal indicating one of the plurality of residents of the building selected by a visitor to the building;
(b) operate the voice recorder and player and the speakerphone to record an identification message from the visitor in response to the selection signal;
(c) signal the resident communication device associated with the selected resident;
(d) operate the voice recorder and player to play the recorded message to the selected resident; and
(e) transmit a signal on the output line to unlock the entry door only when an entry signal is received from the selected resident.

2. The system of claim 1, wherein the microcomputer is further configured to operate the speakerphone to provide voice communication between the visitor and the resident communication device associated with the selected resident in response to a predetermined signal received from the resident communication device.

3. The system of claim 1, further comprising a dual-tone multi-frequency decoder coupled to the network interface and the microcomputer, wherein the entry signal received from the selected resident comprises a dual-tone multi-frequency signal.

4. The system of claim 1, further comprising a keypad coupled to microcontroller, wherein the microcontroller receives the selection signal indicating one of the plurality of residents of the building from the keypad.

5. The system of claim 1, further comprising a display coupled to microcontroller, wherein the microcontroller is further configured to present a listing of at least some of the plurality of residents of the building utilizing the display.

6. The system of claim 1, wherein the microcomputer is further configured to operate the voice recorder and player to play a first message to the visitor to prompt the visitor to provide the identification message.

7. The system of claim 1, wherein the microcomputer is further configured to operate the voice recorder and player to play a second message to the visitor after recording the identification message, wherein the second message provides instructions to the visitor.

8. The system of claim 1, wherein the microcomputer is further configured to:
deny the visitor access to the building when a busy signal is received from the resident communication device associated with the selected resident or when a denial signal is received from the resident communication device associated with the selected resident; and
to operate the voice recorder and player to play a third message to the visitor after denying entry to the visitor, wherein the third message provides instructions to the visitor that entry was not granted.

9. A method for controlling entry to a building, comprising:
(a) receiving a selection signal indicating a selected resident of the building from a visitor;
(b) recording an identification message from the visitor in response to the selection signal;
(c) sending the identification message to a resident communication device associated with the selected resident; and
(d) granting the visitor access to the building when an entry signal is received from the resident communication device associated with the selected resident.

10. The method of claim 9, further comprising playing a first message to the visitor to prompt the visitor to provide the identification message.

11. The method of claim 9, further comprising playing a second message to the visitor after recording the identification message, the second message providing instructions to the visitor.

12. The method of claim 9, further comprising denying the visitor access to the building when a busy signal is received from the resident communication device associated with the selected resident.

13. The method of claim 12, further comprising denying the visitor access to the building when the resident communication device associated with the selected resident does not respond to sending the identification message after a predetermined time interval.

14. The method of claim 13, further comprising denying the visitor access to the building when a denial signal is received from the resident communication device associated with the selected resident.

15. The method of claim 14, further comprising denying the visitor access to the building when a call to the resident communication device associated with the selected resident is terminated prior to receiving the entry signal.

16. The method of claim 14, further comprising playing a third message to the visitor after denying entry to the visitor, the third message providing instructions to the visitor that entry was not granted.

17. The method of claim 9, further comprising providing voice communication between the visitor and the resident communication device associated with the selected resident when a predetermined signal is received from the resident communication device associated with the selected resident

18. A method for controlling entry to a building, comprising:
(a) receiving a selection signal indicating a selected resident of the building from a visitor;
(b) playing a first message to the visitor in response to receiving the selection signal the first message instructing the visitor to supply an identification message;
(c) recording the identification message from the visitor;
(d) signaling a resident communication device associated with the selected resident to place a call;
(e) receiving a response from the resident communication device associated with the selected resident and
(1) when the response indicates that the resident communication device is busy, terminating the call and continues from step (d);
(2) when the response indicates that the telephone is answered,
(A) playing the a fourth message and the recorded identification message to the resident communication device, the fourth message providing a greeting;
(B) receiving a signal from the resident communication device associated with the selected resident; and
(I) when the signal is an entry signal, unlocking an entry door to the building;
(II) when the signal is a denial signal or signal indicating the call is terminated, playing a third message to the visitor, the third message indicating that entry to the building is not granted; and
(III) when the signal is a voice communication request signal, establishing voice communication between the visitor and the resident communication device associated with the selected resident and continuing from step (B).
